(19) United States
(12) Patent Application Publication
(10) Pub. No.: US 2004/0110950 A1
(43) Pub. Date: Jun. 10, 2004

(54) Porous polymeric coordination compounds

(76) Inventors: Jing Li, Cranbury, NJ (US); Long Pan, Westmont, NJ (US); Xiaoying Huang, Piscataway, NJ (US)

Correspondence Address: SYNNESTVEDT & LECHNER, LLP, 2600 ARAMARK TOWER, 1101 MARKET STREET, PHILADELPHIA, PA, 191072950

(21) Appl. No.: 10/718,047

(22) Filed: Nov. 20, 2003

Related U.S. Application Data
(60) Provisional application No. 60/427,761, filed on Nov. 20, 2002.

(51) Int. Cl. C07F 15/00

(52) U.S. Cl. 546/2

(57) ABSTRACT

The present invention describes three-dimensional porous coordination compounds, a method of making the compounds, and a method of using the compounds to contain reactants in a reaction, said compounds characterized by a plurality of sheets comprising a two-dimensional array of repeating structural units comprising at least one transition metal, one polyfunctional ligand and one exodentate ligand wherein: (1) at least one binding member of each said polyfunctional ligand is coordinated to transition metal atoms in two different repeating structural units within one sheet; (2) said binding sites of each exodentate bridging ligand are coordinated to transition metal atoms in a each of two adjacent sheets, and (3) the ligands of the three-dimensional polymeric compound define channels and pores of molecular size throughout the structure of the compound.

### CROSS-REFERENCE TO RELATED APPLICATIONS

The present application is based on and claims the priority of U.S. provisional application No. 60/427,761, filed Nov. 20, 2002, which application is incorporated herein in its entirety by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of MDR-0094732 awarded by The National Science Foundation.

### BACKGROUND OF THE INVENTION

Zeolites are alumino-silicates, their structure being comprised primarily of strong metal-oxygen bonding throughout. They have an extended 3-dimensional structure which includes pores and cavities of molecular dimension within the zeolite. Zeolites have been described in detail by Breck, in “Zeolite Molecular Sieves: Structure, Chemistry and Use”, Wiley & Sons, Inc. New York, 1974 and by Barrer in “Zeolites and Clay Minerals as Sorbents and Molecular Sieves”, Academic Press, London, 1978.

Taking advantage of the high sorption capacity of their porous structure and of their ability to selectively absorb and retain certain classes or configurations of molecules, synthetic zeolites have been found useful as sorption media in separation processes, catalysis, and in control of reactions carried out within the zeolite structure. For some chemical transformations, while the environment provided by a zeolite “super-cage” may be suitable for promoting and/or catalyzing selected reactions, or may “shut off” alternative reaction pathways that lead to unwanted products, recovery of the product from the “super-cage” often requires that the zeolite be dissolved. An example of this is described by Lei et al. in the Journal of the American Chemical Society, Vol. 108 (1986) pp. 2444-2445, and has been described as “ship in a bottle” synthesis.

As indicated above, the chemical bonds comprising a zeolite structure are all of approximately the same type and bond energy, and these bonds are chemically robust. To dissolve a zeolite structure, aggressive chemical attack is required. The dissolution products are unsuitable for re-constituting the zeolite structure afterward without subjecting the products to further chemical transformations. Further, the aggressive nature of the reagents required to dissolve the zeolite structure can also attack the products to be recovered, adversely effecting product yields. Additionally, the zeolite structure is comprised of moieties which are hydrophillic, limiting the reactants used in reactions carried out in zeolites. Additionally, some zeolite structures have sites within the structure that are powerful Lewis acids or Lewis bases, limiting the reactions which can be carried with respect to acid or base sensitivity of the reactants and/or the reaction.

What is needed is a compound having a three-dimensional polymeric structure which is porous, similar to that of a zeolite in its sorption properties, and which contains bonding such that the structure may be “dissolved” under mild conditions to liberate the product(s) of a reaction carried out within its structure.

In “batch” reactions of the type described above as “ship in a bottle” synthesis, it is also advantageous if the sorption media in which the reaction is carried out yields, upon dissolution to recover the product(s) of the reaction, a compound which is easily isolated and readily converted back into the sorption media for use in a subsequent “batch”. This is not the case when zeolites are used as sorption media for “ship in a bottle” type reactions, thus, a porous, three-dimensional polymeric compound is needed which is readily “dissolved” to release reaction product(s) and “reconstituted” from the dissolution products. In this manner, a sorption media is provided from which the products are readily recovered and which can be cycled back into the form of a three-dimensional polymeric compound for reuse as sorption media. Additionally, a compound containing extended, porous structures which are lipophilic and free of strong Lewis acid and base sites is needed.

### SUMMARY OF THE INVENTION

These needs are met by the present invention.

One aspect of the present invention is the provision of a three-dimensional polymeric compound which is characterized by coordination bonding of a plurality of sheets of a two-dimensional array of repeating structural units, each repeating structural unit comprising at least one transition metal atom coordinated to:

a) one binding site of an exodentate bridging ligand; and

b) at least one binding member of a first bidentate binding site on each of two polyfunctional ligands, wherein: (1) at least one binding member of a second bidentate binding site of each polyfunctional ligand is further coordinated to at least one transition metal atom in a different repeating structural unit within a sheet of repeating structural units; (2) the exodentate bridging ligand extends essentially perpendicularly from a plane which is characteristic of the sheet of one said two-dimensional array of repeating structural units to further coordinate with a transition metal atom in a repeating structural unit in an adjacent sheet comprising a two-dimensional array of repeating structural units; (3) the polyfunctional ligand is a ligand having at least two bidentate coordination sites; and (4) the exodentate ligand is a ligand having two monodentate binding sites, wherein the polyfunctional ligand compounds and the exodentate ligand compounds are selected so that: (i) substitution of the exodentate ligands is more facile than substitution of the polyfunctional ligands by a ligand having a single, monodentate coordination site, and (ii) the ligands of the three-dimensional polymeric compound define channels and pores of molecular size throughout the structure of the compound.

Preferred transition metals for use in the compounds of the present invention are those wherein the transition metal is possessed of at least one stable oxidation state in which it is classified as a Pearson “soft” or “borderline” acid, and also possesses some oxidation state in which it can form stable bonds with ligands classified as Pearson “hard” bases.

Another aspect of the present invention is the provision of a process for making a porous, three-dimensional polymeric compound according to the present invention which includes the step of contacting a non-porous precursor polymeric compound containing the transition metal and the polyfunctional ligands with an excess of a compound containing the exodentate ligand under solvo-thermal conditions, wherein the precursor polymeric compound is characterized as having less than three dimensions of polymeric structure.

In a preferred embodiment, the transition metal atom is selected from cobalt and zinc, the polyfunctional ligand of the precursor polymeric compound is 4,4′-biphenyl-dicarboxylate, and the exodentate ligand compound is 4,4′-bipyridine, wherein each exodentate bipyridine ligand coordinates one pyridyl nitrogen atom thereof to a transition metal atom which is in a repeating structural unit in a first sheet of a two-dimensional array of repeating structural units and the other pyridyl nitrogen atom thereof to a transition metal atom in a repeating structural unit in an adjacent sheet of a two-dimensional array of repeating structural units.

Advantageously, the three-dimensional polymeric compounds of the present invention have a porous structure, the organization of which is substantially completely disrupted upon being contacted with liquid water yielding the non-porous precursor polymer compound of lower dimension from which they were synthesized. More particularly, the three-dimensional polymeric compounds of the present invention a have zeolite-like structures with similar utilities, including the ability to promote or catalyze selected reactions, after which the inventive polymeric compounds may be converted to a lower dimensional compound by ligand exchange with water to regenerate the precursor compounds, thereby liberating the reaction product for recovery under very mild conditions. It is also an aspect of the three-dimensional polymeric compounds of the present invention that they can be readily interconverted between the three-dimensional structure of the compounds of the present invention and the structure of their lower-dimensional starting materials and back again by successive treatment of the three-dimensional polymeric compound with water and subsequent treatment of the lower-dimensional product produced thereby with an aliquot of one or more exodentate ligand compounds under solvo-thermal conditions.

### BRIEF DESCRIPTION OF DRAWINGS

FIG. 1a is a graphic representation of a repeating structural unit in a cobalt interpenetrating compound.

FIG. 1b is a graphic representation of a single lattice structure comprising repeating structural units of a cobalt interpenetrating compound.

FIG. 2 is a graphic representation of two interpenetrating lattice structures of repeating structural units of a cobalt interpenetrating compound.

FIG. 3 is a graphic representation of a repeating structural unit of a cobalt pillared/sheet compound.

FIG. 4 is a graphic representation of an interpenetrating lattice sheet comprising the repeating structural units of a single layer of a cobalt pillared/sheet compound.

### DETAILED DESCRIPTION OF THE INVENTION

The present development relates to the formation and use of coordination compounds which have coordination bonding extending in three dimensions, and have a “zeolite-like” porous structure which includes “super-cages” and “channels” of molecular dimension. They are referred to herein as “porous three-dimensional polymeric compounds”.

As the term is used herein, a “sheet of a two-dimensional array of repeating structural units” refers to a structure within a region of a three-dimensional compound of the invention which can be described by translating a structure comprising one or more transition metals bounded to one or more polyfuctional ligands through a plane which does not include any exodentate ligands.

As it is used herein, the terms “soft Pearson acid” and “borderline Pearson acid” as applied to transition metals, and the term “Pearson hard base” as applied to ligands are as defined in “Mechanisms of Inorganic Reactions”, Fred Basolo and Ralph Pearson, 2^{nd} Ed, John Wiley & Sons, New York, 1967.

As it is used herein, the term “borderline Pearson base” as it is applied to ligands is used as defined in Inorganic Chemistry, James E. Huheey, 3^{rd} ed.

As the term is used herein, a structure extending to “polymeric dimension” means that it comprises more than two repeating units in its structure, up to an infinite number of repeating structural units.

As the term is used herein, the “dimensionality” of a compound refers to the minimum number of coordinate dimensions needed to describe the space through which strong chemical bonding of the structure(s) of polymeric dimension in the compound extend. For example, ordinary linear polymers, for example, polyethylene and nylon, are termed one dimensional because these compounds have a basic structure of polymeric dimension which has strong chemical bonds extending in one dimension (linear), even though the “polymeric chain” of these compounds may have “branching structures” which are not of polymeric dimension extending into a second dimension. Lattice compounds, for example graphite, are two-dimensional because the strong chemical bonds of a given graphite plane (the basic structure of polymeric dimension in the compound) extend throughout two dimensions, bonds in the third dimension of the structure being individual planes bonded together by relatively weak Van-der-Waals forces. Zeolites exemplify three-dimensional compounds, the basic structure of polymeric dimension in zeolitic compounds having strong chemical bonds which extend in three dimensions. Reference herein to conversion of compounds from a compound of higher dimensionality to one of lower dimensionality contemplates transformation of a three-dimensional compound to a two or one dimensional compound, or a two-dimensional compound to a one dimensional compound. Reference herein to conversion of a compound of lower dimensionality to one of higher dimensionality contemplates the reverse process. As described above, the compounds of the present development have strong chemical bonds of polymeric dimension extending in three dimensions, thus they are three-dimensional compounds.

The bonding throughout compounds of the present invention comprises coordination bonds. This type of bonding is known in the art and described in, for example, Advanced Inorganic Chemistry, fourth edition, Cotton and Wilkenson, Wiley Interscience, New York, 1980, chapter 2, and is exemplified by the bonding between a ligand, for example, ammonia, and a metal, for example, a transition metal, for example, cobalt, in transition metal coordination complexes, for example [Co(NH₃)₆]⁺³.

As it is generally conceptualized, in coordination bonding the metal is conceptualized as the “center” of the interaction, and is termed “the metal center”. The metal center is conceived of as having “coordination sites” arranged geometrically about it, for example, an “octahedral” arrangement of coordination sites involves four coordination sites located in a plane, equidistant from the metal center (occupying the comers of a square, the metal centered in the square), and two additional coordination sites, one located above and one below the plane, centered over the metal center. A second example is a “trigonal bipyramidal” arrangement of coordination sites, which involves three coordination sites in a plane equidistant from a metal center (occupying the comers of an equilateral triangle, metal centered in the triangle) with two additional coordination sites, one located above and one below the plane and centered over the metal. In coordination compounds, the coordination sites about the metal center are conceived of as being occupied by ligands.

Ligands can be atoms, molecular fragments, or molecules, with or without an electron charge. Ligands have “binding sites”. A ligand binding site is an atom, or group of atoms in close proximity on the ligand that interact with one or more coordination sites of the metal center. The number of coordination sites on a metal center which can be occupied by a given binding site of a ligand is the ligand's “dentate number”. Thus, a ligand having a binding site which can only occupy one coordination site on a metal center is monodentate, a ligand having a binding site which can occupy two coordination sites on a metal center is bidentate, and so forth. Polydentate binding sites for example, a bidentate binding site, are essentially a group of monodentate binding sites arranged in a ligand such that they can interact simultaneously with multiple coordination sites on one metal center. This is to say that a bidentate binding site has two atoms which can interact with a metal center to form a coordinate bound and are in sufficiently close proximity and geometrically disposed such that both atoms of the bidentate ligand binding site can participate in the occupation of two coordination sites (one atom in each site) of a single metal atom. Alternately the binding members can occupy one coordination site on each of two metal atoms in close proximity. Examples of such ligands are those containing a carboxylate, phosphate, sulfate, nitrate, diamino, or amide functional groups. It will be appreciated that other types of binding sites comprising oxygen and/or nitrogen atoms arranged such that two of either atoms are proximate and properly geometrically disposed to each other will also constitute bidentate binding sites. As used herein, each atom of a polydentate binding site on a ligand is referred to as a coordinating member of that binding site. Further, as used herein, a polydentate binding site on a ligand is distinct from a ligand which has multiple monodentate binding sites for example, an exodentate ligand, further described below. A ligand with multiple monodentate binding sites can interact with a single coordination site on several different transition metal centers at the same time, but it can not interact with more than one coordination site on a single metal center at one time. For example, the oxygen atoms of a dicarboxylate group constitute a bidentate binding site with each oxygen atom constituting a coordinating member of that binding site, and the nitrogen atoms of 4,4′-bipyridine constitute two monodentate binding sites in the bipyridine ligand. The oxygen atoms of the dicarboxylate binding site are geometrically disposed that both can simultaneously interact with a different coordination site on a single transition metal center but 4,4′-bipyridine cannot be distorted to bring both nitrogen atoms into the geometrical alignment necessary for both nitrogen atoms to simultaneously interact with two coordination sites on one transition metal.

As mentioned above, the porous, three-dimensional compounds of the present invention comprise a repeating structural unit organized into sheets comprising a two-dimensional array of repeating structural units which are interbonded by ligands coordinate between two transition metal atoms, each located in a repeating structural unit in an adjacent sheet. In compounds of the present invention, a “sheet” of a two-dimensional array of repeating structural units comprises transition metal centers bonded together by organic ligands of one type, termed hereinafter “polyfunctional ligands”. The “polyfunctional ligands” are further described below and extend the strong chemical bonding in the structure of the compound to polymeric dimension in two directions, e.g., the x and y axis of a plane which is characteristic of the sheet which includes it by forming coordination bonds to transition metal centers in two different repeating structural units using coordinating members of two different polydentate sites on the ligand (thus, a two-dimensional array of repeating structural units). The planarity “sheet” itself can vary with respect to the alignment of the constituents of the repeating structural unit. It will be appreciated that the term “sheet” includes a range of structural configurations ranging between a strictly planar arrangement of the constituents of the sheet to an arrangement in which the constituents can be above and below a plane characteristic of the sheet by a distance on the order of a dimension of a repeating structural unit.

The strong chemical bonding in the structure of compounds of the present invention are extended to polymeric dimension in a third direction, e.g. along the “z” axis, perpendicular to the x, y plane described above, by coordination bonding of a second type of ligand which has a different bonding and chemical nature than the polyfunctional ligand. The second type of ligand is termed herein, an “exodentate ligand”. The exodentate ligands, further described below, extend essentially perpendicularly from a plane characteristic of the two-dimensional array of repeating structural units along the “z” axis to form bonds between transition metal atoms in repeating structural units residing in two adjacent sheets of two-dimensional arrays of repeating structural units, using two different monodentate binding sites on the ligand, thus forming a bridge bonding the sheets of two-dimensional arrays of repeating structural units together.

Thus, the polymeric compounds of the present invention can be thought of as sheets of two-dimensional arrays of a repeating structural unit comprising transition metal centers intrabounded by multiple polyfunctional ligands with sheets being interbonded by a plethora of exodentate ligands via inter-sheet coordination of two monodentate binding sites on each exodentate ligand, each to a transition metal center residing within a repeating structural unit of a different sheet of two-dimensional arrays of repeating structural units.

The three-dimensional polymeric compounds of the present invention are further characterized because the ligands of the compound define pores and channels throughout in the compound, the size of which are related to the “length” of the ligands residing between metal centers. This is to say that the interatomic distance between metal centers coordinated to different binding sites of a ligand will be determined by that part of the ligand structure which separates the binding sites of the ligand coordinated to each metal center. It will be appreciated that as the distance between binding sites is increased, the structural features of the resulting three-dimensional polymeric material will concomitantly increase. It will also be appreciated that as the feature size of the three-dimensional material is increased, for example, by increasing the length of the polyfunctional ligands, the gross structure of the three-dimensional polymeric material from whence the porous properties of the compound derive will admit to structural variation in the three-dimensional polymeric compound which is not directly translated into a larger feature size. An example of this is a compound in which the fundamental lattice structure is interpenetrated by a second lattice structure of identical feature size, thereby reducing the gross pore and channel size of the material over that which may be observed when three-dimensional compounds of the present invention are synthesized using ligands having a shorter distance between binding sites.

Without wanting to be bound by theory, it is also thought that structural features of the three-dimensional polymeric compounds of the present invention, for example, the degree of planarity of the two-dimensional array of repeating structural units in a given “sheet” of the compound will also vary as the ratio of ligands and metals is varied.

The compounds of the present invention are synthesized by solvo-thermal ligand substitution. In synthesis by solvo-thermal ligand substitution, a precursor compound comprising a transition metal center and polyfunctional ligands, but containing no exodentate ligands, is heated in the presence of a solvent compound containing exodentate ligands. During the synthesis, two ligands in the lower dimensional precursor compound, each occupying a single, monodentate coordination site in the coordination sphere of a transition metal center, for example, water and pyridine, are substituted by an exodentate ligand compound having two monodentate coordination sites, for example, 4,4′-bipyridine. For the compounds of the present invention, this type of substitution is readily reversible to regenerate the starting compound, or another compound of lower dimension.

Accordingly, to ensure good yields, the solvo-thermal substitution reaction is carried out under conditions in which the substituting ligand compound is present in the reaction mixture in excess and/or the substituted ligands of the precursor compound are removed from or scavenged in the reaction mixture as the substitution proceeds, generally by employing a solvent which binds to the substituted ligands.

Thus, the solvothermal ligand replacement is performed by heating a reaction mixture containing an exodentate ligand compound and a precursor compound in the form of a one or two-dimensional precursor polymeric compound in which the transition metal center and polyfunctional ligands are present in the same relative stoichiometry as is existent in the porous, three-dimensional polymeric compound product and wherein the complex has at least one water ligand coordinated to the metal center. Thus, for example, when a one dimensional polymeric compound of the stoichiometric formula [Mₐ(pbd)_{b}(H₂O)_{c}].d (sol), where: (a) “M” is a transition metal which in at least one stable oxidation state is classified as a Pearson “soft” or “borderline” acid, and which in some oxidation state can form stable bonds with ligands classified as Pearson “hard” or “borderline” bases, (b) “pbd” is a polyfunctional ligand having at least two bidentate coordination sites, (c) “sol” is any solvent molecule, including water; (d) “a”, “b” and “c” are integers selected independently, and the sum of the coordinate space occupied by “b” number of “pbd” ligands+“c” is equal to the coordinate space available in “a” number of M transition metal centers, each in a stable state of coordination; and (e) the complex contains a variable number, “d”, of solvent molecules, for example, water, associated with it, is heated in the presence of an aliquot of an exodentate ligand compound (ed) and a polar solvent, there is formed a compound of the stoichiometric formula [Mₐ(pbd)_{b}ed_{f}].x (polar solvent) z H₂O, where “M”, “pbd”, and “ed” are as described above, “f” is any number less than “c”, the coordination space occupied by “b” number of pbd ligands and “f” number of “ed” ligands is equal to the coordinate space available in “a” number of M transition metal centers, each in a stable state of coordination, and “x” and “z” indicate any number of solvent molecules occupying the space in the pores of the complex (“guest” solvent), the sum of which may be the same as or different than “d” of the precursor lower dimensional complex. These “guest” solvent molecules are generally selected from polar solvents. Generally, guest solvent (water and sol, where “sol” can be any solvent, including a polar solvent) can be removed by evacuating the solid, for example, with reference to the above example compound, to give a compound of the stoichiometric formula [Mₐ(pbd)_{b}ed_{f}].

In the most preferred embodiment, when a one-dimensional precursor complex of the stoichiometric formula [M(pbd)(H₂O)₂].H₂O, is heated with an aliquot of ed, where “M”, “pbd”, and “ed” are as defined above, in the presence of a polar, aprotic, solvent, for example, dimethylformamide (DMF), there is formed a complex of the stoichiometric formula [M₃(pbd)₃ed].4DMF.H₂O.

In general, the solvo-thermal synthesis of complexes of the present development is carried out in an aprotic solvent which can effectively complex water, making it unavailable to participate in a reverse reaction that regenerates the starting material. An example of a suitable aprotic solvent is DMF, which can advantageously form a tight solvation shell around water as it is liberated from the precursor compound, effectively rendering the water unavailable to participate in a reverse reaction.

A second method of synthesizing the three-dimensional polymeric compounds of the present invention is to heat an inorganic transition metal complex having substitutionally labile ligands and the transition metal center in the desired state of charge with the desired polyfunctional ligand compound and exodentate ligand compound present in the a reaction mixture to a controlled stoichiometric ratio with the transition metal complex. For example, by heating M(NO₃)₂.6(H₂O) (hereinafter, an “ic” complex) with a polyfunctional ligand compound (pbd) and an exodentate ligand compound (ed) present in a ratio of ic:pdb:ed of 1:1:4 in a DMF reaction solvent, a three-dimensional polymeric compound of the stoichiometric formula [M(pdb)(ed)] is produced, whereas if the ratio of ic:pdb:ed is altered to be 1:1:1, a three-dimensional polymeric compound of the stoichiometric formula [M₃(pbd)₃)(ed)] is produced.

The compounds of the present invention are further characterized in their ability to be cycled between low dimensional precursor compounds and the three-dimensional polymeric compounds of the present invention by alternately treating the three-dimensional polymeric compound with liquid water to yield the lower dimensional starting material in a form easily isolated, or by treating the isolated lower dimensional starting material with a solution containing an excess of the exodentate ligand under solvo-thermal conditions defined above.

Without wanting to be bound by theory, it will be appreciated that by including both difunctional, mono-dentate, exodentate ligands and difunctional, bidentate, poly functional ligands in a three-dimensional polymeric compound, the present invention provides a complex in which substitution of the exodentate ligands is more facile than substitution of the polyfunctional ligands. In this manner, a complex is provided in which the dimensionality of the compound (both from higher to lower and lower to higher) is readily altered by ligand exchange, rather than, as is the case for zeolitic materials, by degradation of the compound to one or more products which require extensive chemical alteration to be utilized as precursors to regenerate the three-dimensional polymeric compound.

Although the bonding in compounds of the present development comprises substitutionally labile transition metal/ligand bonds, the compounds are thermally robust, with for example, some embodiments withstanding heating to 400° C. The compounds additionally withstand exposure to atmospheric conditions and nitrogen without decomposition. Additionally, these compounds have a porous structure which include “super-cages,” separated by narrower openings, described herein as “windows”. Both of these features have dimensions on the order those of the typical equivalent of zeolites structures, as demonstrated by their ability to adsorb organic molecules, as described below.

Described next are the properties characterizing the transition metal atoms and the polyfunctional and exodentate ligands which comprise the structure (described above) of the compounds of the present development.

### Transition Metal Atoms

The properties of transition metal compounds and of the metal atom(s) and coordinated ligands comprising such compounds are often described in terms of the hard, soft, or borderline acid or base character of the transition metal and its ligands. This concept is described, for example, by Pearson in “Mechanisms of Inorganic Reactions, a study of metal complexes in solution”, Wiley & Sons, New York, 1967, and in “Inorganic Chemistry, Principles of Structure and Reactivity”, 3^{rd} ed., James E. Huheey. Not being bound by theory, transition metal atoms suitable for use in compounds of the present development are selected from transition metals having at least one stable oxidation state classified under the Pearson categories as a soft or borderline acid, for example, iron, cobalt, nickel, zinc, cadmium, palladium, and platinum in the +2 oxidation state, and which are capable of forming (in any oxidation state) stable complexes with ligands classified under the Pearson categories as hard or borderline bases, for example, those which include in their structure one or more nitrogen or oxygen atoms that are available for coordination to a metal center.

It will be appreciated that a compound of the present invention may incorporate more than one species of transition metal atom into its structure that fits into the above-described categories.

While many transition metals may be used within the repeating structural unit of polymeric compounds of the present invention, transition metals which meet the Pearson acid/base characterization defined above in periods 8, 9, 10 and 12 are preferred, with cobalt and zinc being the most preferred transition metals for use in polymeric compounds of the present invention.

Next described are the ligand compounds suitable for use in the compounds of the present invention.

### Polyfunctional Ligand Compounds

The polyfunctional ligand compounds suitable for use in the compounds of the present invention comprise a ligand containing at least two bidentate binding sites (as defined above) disposed in the ligand structure. The bidentate sites of suitable polyfunctional ligand compounds are positioned such that if each of two different transition metal centers are bonded to one bidentate binding site, the resulting structure comprises an essentially colinear arrangement of the ligand and metal atoms with the metal atoms located between about 4 angstroms and about 20 angstroms apart. Further, suitable polyfunctional ligand compounds are characterized as being “rigid,” and therefore not capable of having a conformation that provides for close proximity of these two bidentate binding sites. Ligands having in their structure more than two binding sites are also contemplated, provided that at least two binding sites are bidentate and arranged to give an essentially colinear disposition of the ligand and two metal atoms bound to the bidentate binding sites, as described above. Preferably, the polyfunctional ligand compound used in the pillared, porous, three-dimensional polymeric coordination compounds of the present development have only two bidentate binding sites, but ligands having more than two bidentate binding sites are contemplated, as well as those which have polydentate binding sites and additionally, one or more monodentate binding sites. An example of a polyfunctional ligand compound suitable for use in compounds of the present development is biphenyl-4,4′-dicarboxylate, Structure 1 where “n”=0.

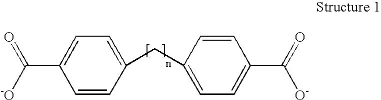

It will be appreciated that any “rigid” dicarboxylate which has a distance of between about 4 angstroms and 20 angstroms between the carboxylate carbons can be used. For example, the biphenyl compounds of the type shown in Structure I for “n”=0 to about 4. Further examples include dicarboxylates based on aromatic dicarboxylic acids, for example terephthalate, and the like. Additional examples include dicarboxylates of muconic acid and succinic acid, and the like. Also exemplifying polyfunctional bidentate ligands are compounds of structure II:

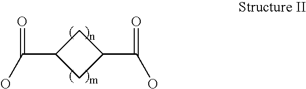

where “m” and “n”=1 to about 3 and are selected independently.

Additional examples are fused-ring compounds of the formula of Structure III:

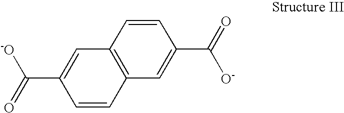

and fused-ring compounds of Structure IIIA:

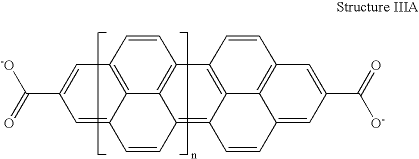

wherein “n” is selected to be 0 to about 2.

It will also be appreciated that compounds can be used having the the formula of

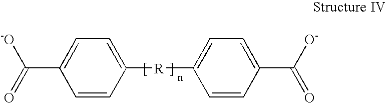

wherein “n” is selected to be 1 to about 2, and “R”can be any “rigid” moiety, for example acetylenic moieties of the structure (C₂)ₘ, where “m”=1-3, disubstituted phenyl and dialkylphenyl moieties of the formula of Structure V:

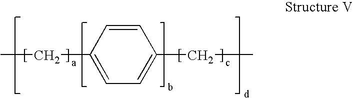

where “a”, “b”, “c” and “d” are selected independently, and “a”and “c” are selected to be 0 to about 2 and “b” is selected to be from 1 to about 2 and “d” is selected to be from about 1 to about 2.

It is expected that as the moiety residing between the carboxylate groups becomes increasingly larger, the resulting structure will have correspondingly larger pore size, and greater flexibility.

It will also be appreciated that by choosing as the coordinating members of the coordination sites comprising the polyfunctional ligand compounds, atoms which have multiple pairs of electrons available for coordination with the transition metal center, for example, oxygen, a ligand compound is provided which possesses coordinating members that can participate in “3-centered” (η-3) coordination interactions, as will be described more fully, below.

### Exodentate Bridging Ligand Compounds

As described above, the three-dimensional polymeric compounds of the present invention can be described as “pillared” compounds, with the “pillars” bonding sheets comprising two-dimensional arrays of repeating structural units together. In the three-dimensional polymeric compounds of the present invention the “pillars” are “exodentate” ligands. Exodentate ligands possess only monodentate binding sites.

As used herein, an exodentate ligand compound is a compound having at least two monodentate binding sites, which are disposed in the ligand compound structure such that two different metal atoms, one bonded to each binding site, and the remaining ligand compound structure are essentially colinear. Suitable exodentate ligand compounds are also characterized as having a rigid structure, which means that they cannot assume a conformation that places the two binding sites proximal to each other. The binding sites of exodentate ligand compounds suitable for use in compounds of the present development are characterized in terms of the Pearson categories described above as hard or borderline bases and are further characterized as “good pi-backbonding ligands,” as that term is defined in “Principles and Applications of Organotransition Metal Chemistry”, Coleman and Hegedus, University Science Books, Mill Valley, Calif., 1980. An example of a suitable exodentate bridging ligand compound is 4,4′-bipyridine, where the binding sites are the unsaturated nitrogen atoms of the two heteroaromatic rings. It will be appreciated that other compounds having the general structure of Structure VI, below, are also suitable exodentate ligand compounds:

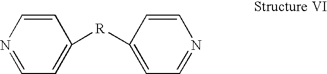

where “R” is a linear or branched, saturated or unsaturated, cyclic or acyclic alkylene group of up to about 3 carbon atoms, a moiety of the structure of Structure VII:

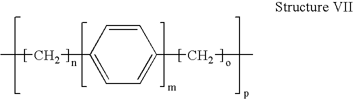

wherein “n” and “o” are selected independently and have a value of from 0 to about 3, and wherein “m” and “p” are selected independently and have a value of from 1 to about 2.

Additional examples include fused ring compounds of the structure of Structure VIII:

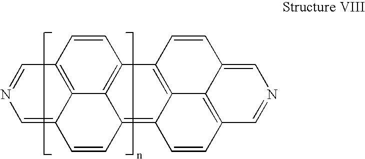

wherein “n” is selected to have a value from 0 to about 2.

In three-dimensional polymeric compounds of the present development, the exodentate ligands are further characterized in that they are substitutionally labile when contacted with an excess of water, for example by suspending the compound in liquid water. As such, the compounds of the present invention are easily converted to the lower dimensionality polymeric precursor compounds from which they are synthesized by substitution of a plurality of the exodentate ligands in the compound each with two molecules of water. It will be appreciated that in addition to substitution of the exodentate ligands by water, other ligands having a single, monodentate coordination site and bonding characteristics similar to water can also be used to substitute for the exodentate ligands in the compound to lower its dimensionality.

Without wanting to be bound by theory, it is thought that the bonding nature of the monodentate ligand makes it more susceptible to substitution than a bidentate ligand, thus, the exodentate ligands of the polymeric compounds of the present invention can have strong bonding interactions, making them thermally robust (as described above) and yet exhibit preferential substitution, which provides for ready conversion between the one dimensional starting material described above and the three-dimensional polymeric compound of the present invention. Although exodentate ligand compounds may have a plethora of monodentate binding sites, preferred exodentate ligand compounds have only two binding sites.

Without wanting to be bound by theory, it is thought that by selecting exodentate ligands which have strong “pi-backbonding” potential, electron density is removed from the transition metal centers of the three-dimensional polymeric compounds of the present invention, enhancing the ability of these metal centers to participate in coordination interactions with the neutral electron pairs of the polyfunctional ligands. Additionally it is thought that such interaction enhances the facile nature of the conversion of the three-dimensional polymeric compounds of the present invention to lower dimensional compounds on treatment with water as well as promotes the formation of the three-dimensional polymeric compounds of the present invention when exposed to one or more exodentate ligands under solvo-thermal conditions.

As described above, the three-dimensional polymeric compounds of the present invention comprise pores, channels, and cavities (super cages) of a dimension suitable for containing molecules which are similar to those same structures found in zeolites. The cavities and channels are accessible via openings of molecular dimension (windows), and accordingly, give the compounds of the present invention a porous quality similar to the porosity of zeolitic materials. It is well known that under ordinary conditions of temperature and pressure these porous materials can trap molecules of appropriate size which have penetrated into the porous structure of the compound. This property can be used to advantage in absorbing and/or controlling the reaction of organic molecules.

The channels and super cages of the three-dimensional polymeric coordination compounds of the present invention comprise structures which are lipophilic, distinguishing them from zeolites which are by-and-large comprised of structures which are hydrophilic, making the compounds of the present invention especially good at absorbing lipophilic organic molecules. This is discussed in further detail, below.

Organic molecules can be introduced into the structure either by treating a three-dimensional polymeric compound of the present development with the organic molecule in vapor phase, or by dissolving the organic molecule in a high vapor pressure solvent, placing the compound into the solution and removing the solvent by evaporation or vacuum distillation.

It will be appreciated that numerous photolytic and other reactions can be carried out in super cages of the three-dimensional polymeric compounds of the present development, the product distribution of which can be controlled by virtue of the limited reaction volume available within which the reactive species can interact with other species or change conformation once generated within the structure of the three-dimensional polymeric compound. As described above, reactions of this type, those in which the reactive species is “trapped” within a cavity or channel of a porous structure, have been described as “ship in a bottle” reactions.

It will also be appreciated that the polymeric compounds of the present invention can be employed to separate mixtures of hydrophillic and lipophilic molecules using pressure swing absorption techniques similar to those which are used for separating weakly from strongly polarizable molecules using zeolites.

It will also be appreciated that catalytic reactions for example hydrogenation or partial oxidation of unsaturated alkylene moieties, can be carried out within the pore structure of three-dimensional polymeric compounds of the present invention by including a catalytic transition metal, for example any of the d-8 transition metals (those of groups 8, 9 and 10 of the periodic chart) in a cavity or channel of the compound.

Presented below are examples of how to make and use the polymeric compounds of the present development.

### EXAMPLES

There follows two examples (Examples 1 and 3) of the synthesis of a three-dimensional polymeric compound of the present invention from a one-dimensional precursor polymer, and one example (Example 2) of the synthesis of a three-dimensional polymeric compound of the present invention from a two-dimensional precursor polymer. In the first example, a three-dimensional polymeric compound comprising a polymeric compound of the stoichiometric formula [Co₃(bpdc)₃(bpy)].4(DMF).(H₂O), where bpdc is biphenyl-4,4′-dicarboxylate, bpy is 4,4′-bipyridine, and DMF is dimethyl formamide, hereinafter, the “interpenetrating cobalt compound”, was synthesized as described below. Its porous structure was characterized by single crystal x-ray diffraction analysis, by its sorption capacity for propylene, n-hexane, and cyclohexane and in comparison with zeolitic materials by its sorption rate for n-hexane.

For Examples 1 to 3, X-ray diffraction analysis was carried out on an Enraf-Nonius CAD4 defractometer equipped with graphite monochromatized MoKα radiation (λ=0.71073 A). Sorption studies were carried out also for Examples 1 to 3 on a computer controlled Dupont Model 990 TGA, with hydrocarbon partial pressures varied by varying the ratio of hydrocarbon to nitrogen admitted to the sample. Sorption studies utilized a sorbate partial pressure that was between about 2% and about 10% of the vapor pressure of the sorbate under conditions of the study.

For Example 1, diffusion rates for cyclohexane in the cobalt compound were calculated by comparison of sorption curves for cyclohexane on similar size crystallites of both zeolite H-Y and H-ZSM-5. The comparison zeolite samples were prepared by heating under dry nitrogen to a temperature of 500° C., and the cobalt bipyridine polymeric compound sample was prepared by heating to 300° C. under nitrogen flow of 1 atm at 100 ml/minute).

In the second example, a three-dimensional polymeric compound comprising a polymeric compound of the stoichiometric formula [Co(bpdc)(bpy)].0.5(DMF), where bpdc is biphenyl-4,4′-dicarboxylate, bpy is 4,4′-bipyridine, and DMF is dimethyl formamide, hereinafter, the “pillared/sheet cobalt compound”, was synthesized as described below. Its porous structure was characterized by single crystal x-ray diffraction analysis, as described above. The sorption capacity of the pillared/sheet cobalt compound was studied for a number of hydrocarbon compounds using the procedure described for the interpenetrating cobalt compound.

In the third example, exemplified are two routes for synthesizing a three-dimensional polymeric compound which is analogous to the interpenetrating cobalt compound and which has the stoichiometric formula [Zn₃(bpdc)₃(bpy)].4(DMF).(H₂O), where bpdc is biphenyl-4,4′-dicarboxylate, bpy is 4,4′-bipyridine, and DMF is dimethyl formamide, hereinafter, the “zinc polymeric compound”.

Synthesis was carried out using reagents and solvents “as received” unless otherwise noted.

### Example 1

### Synthesis of the Interpenetrating Cobalt Compound

A porous pillared polymeric coordination compound of the present invention, having the stoichiometric formula [Co₃(bpdc)₃(bpy)].4(DMF).(H₂O), (also referred to herein as the “the interpenetrating cobalt compound”) where “bpdc”, “bpy” and “DMF” are as described above was synthesized by contacting a precursor polymeric compound having the stoichiometric formula [Co(bpdc)(H₂O)₂].(H₂O) (also referred to herein as the “first cobalt precursor polymer”), synthesized as described below and used as prepared, with 4,4′-bipyridine (ACROS, reagent grade), according to the following procedure.

Into a vessel was placed about 10 ml of dimethyl formamide (Fisher, 99%) which contained about 0.1 millimole of 4,4′ bipyridine under ambient atmospheric conditions. Into this, with stirring at ambient temperature (about 25° C.), was added about 0.3 millimoles of the first cobalt precursor polymer, (prepared as described below). Stirring was continued until the mixture was homogeneous, (about 10 minutes). The mixture was transferred in air to a Parr acid digestion bomb which was then sealed. The mixture was heated to 150° C. and held at that temperature for 3 days, yielding crystals of the interpenetrating cobalt compound in about 95% yield based on the weight of the first cobalt precursor polymeric compound.

Synthesis of the First Cobalt Precursor Polymer

The first cobalt precursor polymer used in the synthesis of the interpenetrating cobalt compound of Example 1 was itself synthesized according to the following procedure. At room temperature (about 25° C.), into a vessel containing about 5.5 mL of a 0.01 molar bis-sodium biphenyl-4,4′-dicarboxylate aqueous solution (about 0.55 millimoles of the dicarboxylate, prepared as described below) was placed about 10 mL of a 0.1 molar aqueous Co(NO₃)₂ solution (about 1.0 millimoles of cobaltous nitrate (Fisher) dissolved in 10 ml of deionized water). This immediately precipitated a gray mass of the first polymer precursor compound (stiochiometric formula [Co(bpdc)(H₂O)₂].(H₂O)], where “bpdc” is biphenyl-4,4′-dicarboxylate). The precipitate was washed with distilled water and used as prepared. Yield was about 92% based on starting cobaltous nitrate.

Bis-sodium-biphenyl-4,4′-dicarboxylate solution was prepared by combining biphenyl-4,4′-dicarboxylic acid (Aldrich, reagent grade) and sodium hydroxide in distilled water in a ratio of about one mole of the acid to about two moles of the hydroxide, and heating the mixture to about 80° C. for about 1 hour. The resulting sodium salt solution was used as prepared.

Analysis of the Interpenetrating Cobalt Compound

X-Ray analysis of the interpenetrating cobalt compound prepared in Example 1 above showed that the material crystallizes in an orthorhombic crystal system, space group Pbcn, with the following lattice parameters: “a”=14.195(3) Å, “b”=25.645(5) Å, “c”=18.210(4) Å, Vol.=6629(2) Å³, Z=4, and d_{calc}=1.367 g cm⁻³.” Crystallization solvent was removed from a second crystal of the compound by heating in air to 300° C. over thirty minutes. This crystal was subjected to analysis by X-ray diffraction. These results indicate that the solvent-free lattice parameters were: “a”=13.950 (3) Å, “b”=25.999 (5) Å, and “c”=18.0989 (4) Å, Vol.=6561 Å³, Z=4, and d_{calc}=1.067 g cm⁻³.

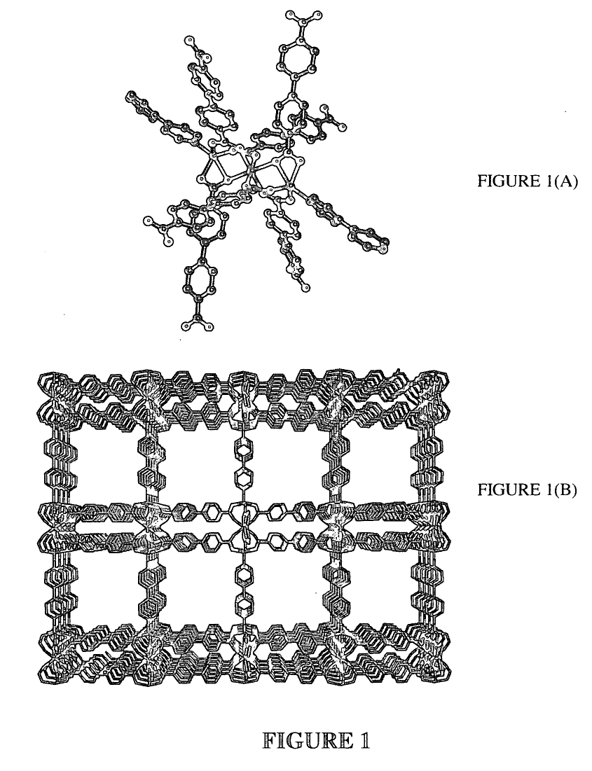

The crystallographic data further indicates that the material has a repeating structural unit (depicted graphically in FIG. 1 a) containing one octahedrally coordinated cobalt atom defining a C₂ rotational axis with two cobalt atoms that are of trigonal bipyramidal coordination positioned in rotational symmetry on either side. It further shows that the three cobalt atoms of the structural unit are bonded together by one binding site of each of 6 biphenyl-4,4′-dicarboxylate ligands (the polyfunctional ligands in this compound). The remaining binding site of each of the six ligands participates in bonding with cobalt atoms comprising different structural unit of the compound.

The crystallographic data indicates that one bidentate binding site of each of four biphenyl-4,4′-dicarboxylate ligands has one oxygen atom of the carboxylate group coordinated to the octahedrally coordinated central cobalt atom and the other symmetrically coordinated to one of the two cobalt atoms having trigonal bipyramidal coordination. Both coordinating members of one binding site of each of two additional biphenyl-4,4′-dicarboxylate ligands (both oxygen atoms of the carboxylate moiety) are bonded, one binding site to each, to the trigonally bipyramidal coordinate cobalt atom and further, one coordinating member (oxygen atom) of each binding site exhibits an η₃ bonding pattern by additionally occupying a coordination sites on the central octahedrally coordinate cobalt atom. The remaining coordination site on each trigonal bipyramidal coordinate cobalt atom is occupied by one nitrogen of each of two 4,4′-bipyridine ligands (one on each cobalt atom, the bipyridine moiety extending in opposite directions along the “a” axis when the two cobalt atoms of trigonal bipyramidal coordination and the one cobalt atom of octahedral coordination along with their associated polyfunctional ligands are oriented to lie in a “bc” plane). A sheet comprising a two-dimensional array of this three-cobalt-atom repeating structural unit can be formed by translating the structural unit along a plane characteristic of the sheet where the unused binding sites of the various ligands described above participate in identical coordination with transition metal atoms in other repeating structural units within the sheet. Translation of the repeating structural unit yields a two-dimensional array of repeating structural units which can be characterized as a lattice structure consisting of a double row chain of alternating biphenyl-4,4′-dicarboxylate ligands and cobalt atoms colinear with the “b” axis, one each from the two trigonal bipyramidal coordinate cobalt atoms of the repeating structural unit, and a single row of three cobalt atoms alternating with diphenyl-4,4′-dicarboxylate ligands colinear with the “c” axis, essentially co-linear with the three cobalt atoms of the repeating structural unit.

The bipyridine ligands are normal to the “bc” plane which is characteristic of a sheet comprising the two-dimensional array of repeating structural units described above, and rotationally symmetric (one up, one down) to the central cobalt atom of the repeating structural unit. They form bridges that bond together sheets comprising the two-dimensional array of repeating structural units containing cobalt atoms and biphenyl-4,4′-dicarboxylate ligands described above. This sheet structure is depicted in graphically in FIG. 1b.

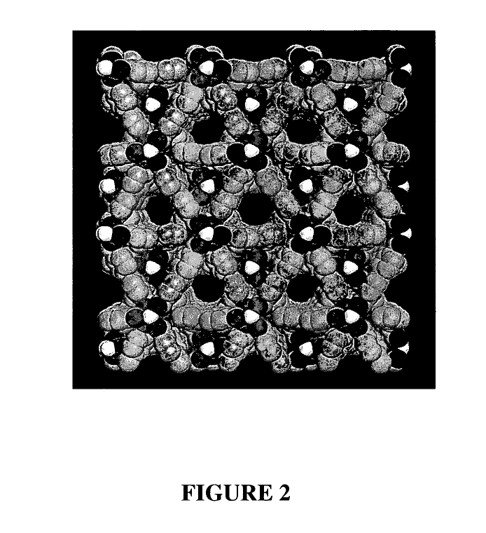

Crystallographic analysis further shows that the lattice described above forms crystals having two interpenetrating lattice structures, with a cluster of 3 cobalt atoms of one repeating structural unit of the “a” lattice residing centered between corners of a cube defined by four clusters in a two-dimensional array of of three-cobalt-atom repeating structural units in each of two sheets of the “b” lattice one sheet residing above and one below the three-cobalt-atom-cluster of the “a” lattice repeating structural unit. The interpenetrating structure is shown in FIG. 2.

Sorption Studies Using the Interpenetrating Cobalt Compound

Crystallites of the interpenetrating cobalt compound prepared above in Example 1 were characterized by absorption capacity at 80° C. using vapors of cyclohexane (55 torr), n-hexane (90 torr), and propylene (600 torr). These studies showed that the interpenetrating cobalt compound absorbs 12 wt % of propylene, 15 wt % of n-hexane, and 19 wt % of cyclohexane, similar to zeolite H—Y which absorbs 17 wt % of cyclohexane under the same conditions. This shows that the polymeric compounds of the present invention are lipophilic and have higher absorption capacity for hydrocarbons than zeolites.

The rate of sorption of n-hexane for the interpenetrating cobalt compound was compared with that of similar-sized crystallites of H—Y and H-ZSM-5 zeolite. The calculated diffusion constant for the interpenetrating cobalt compound was found to be between that of the two zeolite materials, suggesting that the “window” size of the interpenetrating cobalt compound is mid-way between that of the two zeolite materials, having its smallest dimension greater than about 5.3 A (zeolite H-ZSM-5) and less than about 7.4 A (Zeolite H—Y), in agreement with the crystallographic data, from which the “window” size of the interpenetrating cobalt compound of Example 1 is calculated to have an effective maximum dimension of about 8 Å.

It will be appreciated that selection of exodentate and polyfunctional ligands which are longer or shorter than those comprising the three-dimensional polymeric compound of the example will alter the effective size of the various structural features of the resultant compounds.

In Example 2, the preparation of the pillared/sheet cobalt compound is described. The compound of Example 2 utilizes the same ligands and metal as the interpenetrating cobalt compound. The pillared/sheet cobalt compound is a structural variation of the interpenetrating cobalt compound described in Example 1, and is prepared from a two-dimensional precursor in contrast to the preparation of the interpenetrating cobalt compound which utilizes a one-dimensional polymeric precursor compound in its preparation.

### Example 2

### Synthesis of a Pillared/Sheet Cobalt Compound

A second example of a compound of the present invention was prepared from a two-dimensional precursor polymer. Thus, a pillared/sheet cobalt compound having the stoichiometric formula [Co(bpdc)(bpy)].0.5(DMF), where “bpdc”, “bpy” and “DMF” are as described above, was synthesized by contacting a two-dimensional precursor polymeric compound having the stoichiometric formula [Co(bpdc)(py)₂].(H₂O) (second cobalt precursor polymer) with 4,4′-bipyridine (ACROS, reagent grade) in the ratio of 1 mole of precursor to 4 moles of bipyridine according to the following procedure.

Into a teflon-lined autoclave of about 23 ml volume was placed about 5 ml of dimethyl formamide (article of commerce, used as received) about 48 mg of the second cobalt precursor polymer (synthesized as described below and used as prepared) and about 64 mg of 4,4′bipyridine under ambient atmospheric conditions. The autoclave was sealed and heated to about 120° C. The autoclave was maintained at about 120° C. for about 24 hours. Throughout the reaction period the autoclave remained sealed, and accordingly the reaction proceeded at the pressure conditions obtained by maintaining the reactor at about 120° C. (autogenous pressure conditions). At the end of 24 hours, the autoclave was cooled to ambient temperature (about 25° C.) and orange needles of the pillared/sheet cobalt compound were obtained in about 90% yield based on the weight of the second cobalt precursor polymeric compound.

Synthesis of the Second Cobalt Precursor Polymer

The synthesis of the second cobalt precursor polymer, which is used in the synthesis of the pillared/sheet cobalt compound of Example 2, is described by Pan et al. in Inorganic Chemistry, 2000 (39) pages 5333-5340, which is incorporated herein in its entirety by reference. The synthesis was carried out according to the following procedure. Into a vessel containing an 8:1 v/v ratio of pyridine:water was placed 6.7 g of the first cobalt polymeric precursor, the 1-d polymer precursor having a stiochiometric formula [Co(bpdc)(H₂O)₂].(H₂O)], where “bpdc” is biphenyl-4,4′-dicarboxylate, prepared as described above in Example 1. The first polymeric precursor was left to stand immersed in the aqueous pyridine solution for about 3 hours, in that time turning color from gray to pink. When the material had turned pink in color it was isolated by filtration, washed with water, and subjected to elemental analysis, which indicated that the second cobalt polymeric precursor was produced in about 78% yield based on starting cobalt.

Analysis of the Pillared/Sheet Cobalt Compound

X-Ray analysis of the pillared/sheet cobalt compound prepared in Example 2 was carried out using the procedure described above in Example 1. The analysis showed that crystals of the material comprise space group C2/c (No. 15), with the following lattice parameters: “a”=9.523 (2) Å, “b”=20.618 (4) Å, “c”=25.814 (5) Å, β=96.20 (3)°, Vol. =5050.5 (17) Å³, Z=4, and d_{calc}=1.294 g cm⁻³.”

Powder x-ray diffraction of heated samples indicates that the material is stable when heated up to 350° C.

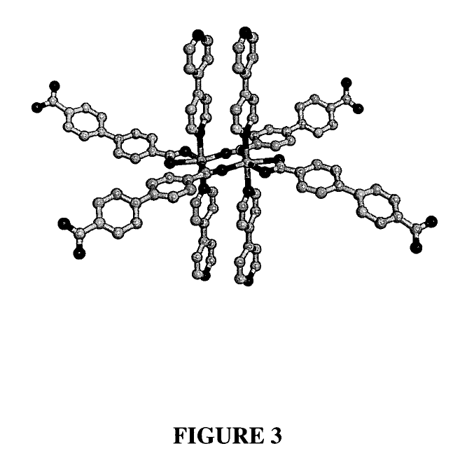

The crystallographic data indicate that the material has a repeating structural unit containing two octahedrally coordinated cobalt atoms defining a C₂ rotational axis, wherein each cobalt atom of the repeating structural unit is coordinated apically to one nitrogen atom of each of two bipyridine ligands and equatorially the structural unit contains four bipyridine dicarboxylate ligands, each of which contributes one dicarboxylate functional group to the structural unit. Each of the cobalt atoms of the repeating structural unit is coordinated to both oxygen atoms (coordinating members) of one carboxylate functional group of one bipyridine dicarboxylate ligand and to one oxygen atom coordinating member of one carboxylate group on each of two additional bipyridine dicarboxylate ligands. Thus, one carboxylate group of each of two of the bipyridine dicarboxylate lignads forms a “bridge” between the two cobalt atoms of the repeating structural unit. The repeating structural unit is graphically presented in FIG. 3.

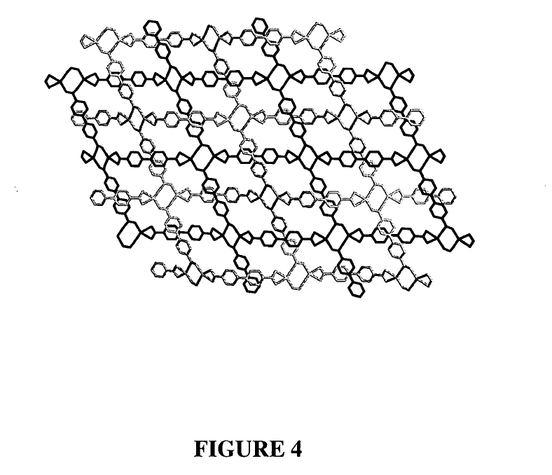

The repeating structural units are linked in two dimensions through the bipyridine dicarboxylate ligands in the form of a grid. Thus, each of the coordinated bipyridine dicarboxylate ligands in a given repeating structural unit also has one carboxylate functional group which is coordinated to a cobalt atom in a different repeating structural unit in grid. The layers of the compound comprise two interpenetrating grids. In this manner, each layer is an undulating lattice sheet of repeating structural units, the bipyridine dicarboxylate ligands of each grid being severely bent to accommodate the bipyridine dicarboxylate ligands of the other interpenetrating grid. The two grids are aligned such that the cobalt atoms of a repeating structural unit in one grid lie centered in two dimensions between four sets of cobalt atoms of repeating structural units of the other grid. The interpenetrating lattice sheet is graphically depicted in FIG. 4.

The apical bipyridine ligands extend essentially perpendicularly to a plane which includes the undulating lattice sheet that comprising the two interpenetrating grids of repeating structural units. Accordingly, each apical bipyridine ligand has one nitrogen coordinated to a cobalt atom in a given layer, and the other coordinated to a cobalt atom in a sheet above or below the given layer. Accordingly, crystallographic analysis shows that the material comprises a series of one-dimensional channels running along the lattice sheets of the material. These channels have a window size of approximately 5.6×3.0 Å. It further shows that the compound comprises “stacks” of layers comprising the lattice sheets bound together through the apical bipyridine ligands.

Sorption Studies Using the Pillared/Sheet Cobalt Compound

Crystallites of the pillared/sheet cobalt compound prepared above in Example 2 were characterized by measuring their absorption capacity at 30° C. using vapors of the hydrocarbons listed below in Table 1 in accordance with the above-describe procedure. Prior to adsorption measurements, the material was heated in the ambient environment to about 200° C. to remove adsorbed dimethyl formamide.

TABLE 1

| Ex. No. | Hydrocarbon | *P/P° | Wt. % Sorbed |
|---|---|---|---|
| 1a | Propene | 0.06 | 11 |
| 1b | n-Hexane | 0.48 | 10 |
| 1c | Cyclohexane | 0.45 | 9 |
| 1d | p-Xylene | 0.34 | 11 |
| 1e | m-Xylene | 0.37 | 15 |
| 1f | Mesitylene | 0.27 | 11 |
| 1g | trisisopropylbenzene | 0.90 | 1 |

*P/P° is the ratio of the partial pressure (P) of the hydrocarbon used in the determination to the vapor pressure of that hydrocarbon.

These data indicate that the pillared/sheet cobalt compound has a surprisingly large absorption capacity for molecules which are in theory too large to pass the 5.6×3.0 Å channel window in the material, for example, mesitylene, which is too large to be adsorbed into ZSM-5 which has 5.5×5.5 Å channels. This indicates that the material has a flexible structure which permits it to accommodate these larger molecules, unlike the more rigid alumino-silicate structure of zeolites.

### Example 3

### Synthesis of the Zinc Polymeric Compound

A pillared porous polymeric coordination compound of the present invention, having the stoichiometric formula [Zn₃(bpdc)₃(bpy)].4(DMF) (H₂O) (zinc polymeric compound) where “bpdc”, “bpy” and “DMF” are as described above for the interpenetrating cobalt compound, was synthesized by contacting a precursor polymeric compound having the stoichiometric formula [Zn(bpdc)(H₂O)₂].(H₂O), (the zinc precursor polymer) synthesized as described below and used as prepared, with 4,4′-bipyridine, according to the following procedure.

Into a vessel was placed about 10 ml of dimethyl formamide (Fisher, 99%) which contained about 0.1 millimole of 4,4′ bipyridine under ambient atmospheric conditions. Into this, with stirring at ambient temperature (about 25° C.), was added about 0.3 millimoles of the zinc precursor polymer. Stirring was continued until the mixture was homogeneous, (about 10 minutes). The mixture was transferred in air to a Parr acid digestion bomb which was then sealed. The mixture was heated to 150° C. and held at that temperature for 3 days, yielding crystals of the zinc polymeric compound in about 94% yield based on the weight of the zinc precursor polymer compound.

Synthesis of the Zinc Precursor Polymer

The zinc precursor polymer compound used in the synthesis of the zinc polymeric compound of Example 3 was itself synthesized according to the following procedure. At room temperature (about 25° C.), into a vessel containing about 5.5 mL of a 0.01 molar bis-sodium biphenyl-4,4′-dicarboxylate aqueous solution (about 0.55 millimoles of the dicarboxylate, prepared as described below) was placed about 10 mL of a 0.1 molar aqueous Zn(NO₃)₂ solution (about 1.0 millimoles of zinc nitrate hexahydrate (Fisher) dissolved in 10 ml of deionized water). This immediately precipitated a mass of the zinc polymer precursor compound (stiochiometric formula [Zn(bpdc)(H₂O)₂].(H₂O)], where “bpdc” is biphenyl-4,4′-dicarboxylate). The precipitate was washed with distilled water and used as prepared. Yield was about 90% based on starting zinc nitrate.

Bis-sodium-biphenyl-4,4′-dicarboxylate solution was prepared as described above in the preparation of the first cobalt precursor polymer, as described above in Example 1.

Direct Synthesis of the Zinc Polymeric Compound

It has been found that the zinc polymeric compound can be synthesized directly from zinc nitrate hexahydrate by treating the nitrate with a mixture of 4,4′-biphenyldicarboxylic acid and 4,4′-bipyridine under the solvo-thermal conditions described above. Thus, about 0.1 mM of Zn(NO₃)₂.6 H₂O was dissolved in 5 ml of DMF. To this was added, with stirring, about one mM of 4,4′-biphenyldicarboxylic acid and about one mM of 4,4′-bipyridine. The reaction mixture thus prepared was transferred in air into a Parr acid digestion bomb which was sealed. The Parr bomb was heated to about 150° C. and held at that temperature for about three days. Crystals of the zinc polymeric compound were recovered from the reaction mixture at the end of the heating period in about 92 weight % yield based on starting zinc nitrate.

### Example 4

### Direct Synthesis of [Zn(bpdc)(bpe)].(DMF)] Three-Dimensional Porous Polymeric Coordination Compound

A three-dimensional polymeric compound of the present invention having the stiochiometric formula [Zn(bpdc)(bpe)].(DMF), wherein bpdc is 4,4′-biphenyldicarboxylate, and “bpe” is 1,2-[4-pyridyl]-ethane is prepared by dissolving in an aliquot of DMF, Zn(NO₃)₂.6 H₂O (“Zn inorganic”), an aliquot of 4,4′-biphenyl-dicarboxylic acid (“H₂bpdc”), and aliquot of 1,2,[4-pyridyl]-ethane (“bpe”) in a stiochiometric ratio of “Zn-inorganic”: “H₂bpdc”: “bpe” of 1:4:1, and heating the mixture using an oven operating at 80° C. for a period of about 72 hr. The complex will spontaneously precipitate and is recovered by filtration of the reaction mixture.

Next is described an example of using the porous structure of a pillared porous polymeric coordination compound of the present invention to control the product distribution of the reaction. This example also illustrates the cyclic nature of the conversion of the three-dimensional structure of the polymeric compound of the present invention to its lower-dimensional precursor compound from which it can be reconstituted by isolation of the precursor and treating it with an aliquot of an exodentate ligand under solvo-thermal conditions.

The example reaction described is the photolysis of ortho-methyl-dibenzyl-ketone. Photolysis of the ketone itself has been described by Torro, et al. in the Journal of the American Chemical Society, Vol. 105, page 1861 (1983), which description is incorporated herein by reference.

Photolysis of ortho-methyl-dibenzyl-ketone which has been adsorbed onto zeolites, for example, NaX, is known to produce a statistical mixture of products that are thought to arise from rearrangements and recombination of radicals photolytically generated from the starting compound. These products are illustrated as species I-IV in Equation 1, shown below.

As shown in Equation 1, Species I, a cyclopentanol, is typically found in about 10 wt % yield, with species III and IV occurring in about 10 wt % yield each, and species II occuring in about 80 wt % yield based on 100% conversion of the starting ketone.

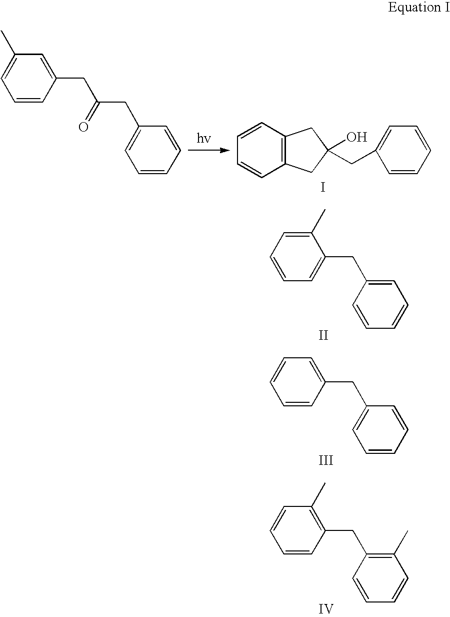

### Example 5

### Control of Reactions Using Three-Dimensional Polymeric Compounds of the Present Invention

The photolysis of ortho-methyl-dibenzyl-ketone which had been absorbed into the structure of a sample of the interpenetrating cobalt compound prepared above in Example 1 has been carried out to demonstrate the ability of pillared porous polymeric coordination compounds of the present development to alter the product distribution observed for such reactions when the reactions are carried out within the supercage of the polymeric compound.

This photolysis was carried out according to the following procedure. Into a quartz cell was placed about 50 milligrams of the interpenetrating cobalt compound prepared in Example 1 above. The cell was purged with argon, and an argon atmosphere was maintained in the cell. Under argon, about 0.3 ml aliquot of a solvent comprising diethyl ether and pentane present in a volumetric ratio of about 1:1 which contained about 2 mg of ortho-methyl-dibenzyl-ketone (hereinafter, “the ketone”) was transferred to the cell. The interpenetrating cobalt compound was left in contact with the ketone-containing solvent for about two hours. The volatile materials remaining after two hours were evaporated by passing a stream of argon gas through the cell. The cell was then sealed and evacuated to a pressure of 2×10⁻⁵ torr. The materials were held under vacuum for about 12 hours, after which the cell was refilled with argon.

Thus prepared, the sample was irradiated by a 500 watt medium pressure mercury vapor lamp for about one hour. After the irradiation period, the material in the cell was subjected to a single ether extraction using about 50 ml of diethyl ether. Following this, the interpenetrating cobalt compound in the cell was converted to its one dimensional precursor polymer by contacting it with about 1 ml of deionized water. The slurry comprising the water and precursor polymer was extracted with one aliquot of about 50 ml of diethyl ether. The ether extracts were analyzed by GC-MS to identify products and measure their yield. This analysis showed that the product comprised about 40 mole % of the cyclization product (the cyclopentanol, species I) and about 60 mole % of the decarbonylation product, species II. None of species III or IV were detected.

This demonstrates that the inventive pillared porous polymeric coordination compounds of the present invention can be used to select or suppress reaction pathways, and the products of those reactions can be recovered under mild conditions which yield species that can be recycled to reconstitute the pillared porous polymeric coordination compound.

It will be appreciated that there are numerous other embodiments of compounds of the present invention of which the foregoing examples are non-limiting illustrations.

1. A three-dimensional polymeric coordination compound characterized by a plurality of sheets comprising a two-dimensional array of repeating structural units, each repeating structural unit comprising at least one transition metal atom coordinated to:
a) one binding site of an exodentate bridging ligand; and
b) at least one binding member of a bidentate binding site on each of two polyfunctional ligands,
wherein: (1) at least one binding member of a second bidentate binding site on each said polyfunctional ligand is further coordinated to at least one transition metal atom in a different repeating structural unit within the same said sheet containing a two-dimensional array of repeating structural units;
(2) the exodentate bridging ligand extends essentially perpendicularly from a plane characteristic of said sheet containing a two-dimensional array of repeating structural units to further coordinate with a transition metal atom in a repeating structural unit in an adjacent sheet; (3) the polyfunctional ligand is a ligand having at least two bidentate coordination sites; and (4) the exodentate ligand is a ligand having two monodentate binding sites,
wherein the polyfunctional ligand compounds and the exodentate ligand compounds are selected so that (i) substitution of the exodentate ligands is more facile than substitution of the polyfunctional ligands by a ligand having a single, monodentate coordination site, and (ii) the ligands of the three-dimensional polymeric compound define channels and pores of molecular size throughout the structure of the compound.

2. The compound of claim 1 wherein the repeating structural unit of the compound has the stoichiometric formula [Mₐ(pbd)_{b}ed_{f}].x(sol).z H₂O, where “M” is a transition metal selected from the group of transition metals having in at least one stable oxidation state classified as a Pearson soft or borderline acid, and which, in some oxidation state, can form stable bonds with ligands selected from the group consisting of ligands classified as Pearson hard bases and ligands classified as Pearson borderline bases, “pbd” is a polyfunctional ligand having at least two bidentate binding sites, “ed” is an exodentate ligand having at least two monodentate binding sites, sol is one or more members of the group selected from polar solvents, “a” and “b” are integers and the coordinate space occupied by the pbd and ed ligands is equal to a stable coordination number of “a” number of M transition metal atoms, and wherein “x” and “z” are any number of solvent molecules including zero.

3. The compound of claim 2 wherein “M” is cobalt, “pbd” is biphenyl-4,4′-dicarboxylate, “ed” is 4,4′bipyridine “sol”=dimethyl formamide, “a” and “b”=3, “f”=1, “x”=4, and “z”=1, the compound being further characterized in that the three cobalt atoms of the repeating structural unit are arranged such that one octahedral coordinate cobalt atom resides between two cobalt atoms having trigonal bipyramidal coordination, the octahedral ligands comprising one oxygen atom (a binding member) of a bidentate binding site of each of six biphenyl-4,4′-dicarboxylate polyfunctional ligands, the trigonal bipyramidal ligands comprising one oxygen atom of a bidentate binding site of each of two biphenyl-4,4′-dicarboxylate polyfunctional ligands, two oxygen atoms of one additional bidentate binding site of a biphenyl-4,4′-dicarboxylate polyfunctional ligand, and the nitrogen of one monodentate binding site of a 4,4′-bipyridine exodentate ligand.

4. A method for preparing a pillared porous polymeric coordination compound having the stiochiometric formula [Co₃(bpdc)₃(bpy)].4(DMF).(H₂O), where (bpdc) is a biphenyl-4,4′-dicarboxylate polyfunctional ligand, bpy is a 4,4′-bipyridine exodentate ligand, and DMF is dimethylformamide, comprising contacting a polymeric precursor compound of the stiochiometric formula [Co(bpdc)(H₂O)₂].(H₂O), where (bpdc) is a biphenyl-4,4′-dicarboxylate polyfunctional ligand, with bipyridine under solvothermal ligand-replacement conditions.

5. A process for the synthesis of a pillared porous polymeric coordination compound of the stiochiometric formula: [M₃(pbd)₃ed].x DMF.zH₂O, where M is a transition metal selected from the group of transition metals having in at least one stable oxidation state classified as a Pearson soft or borderline acid, and which, in some oxidation state, can form stable bonds with ligands selected from the group consisting of ligands classified as Pearson hard bases and ligands classified as Pearson borderline bases, “pbd” is a polyfunctional ligand having at least two bidentate binding sites, “ed” is an exodentate ligand having at least two monodentate binding sites, and wherein “x” and “y” are selected independently to be any number of solvent molecules including zero, comprising contacting a compound of the stiochiometric formula [M(pbd)(H₂O)₂].(H₂O) with an ed compound in the presence of dimethyl formamide under solvothermal ligand replacement conditions.

6. The synthesis process of claim 5, wherein “pbd” is biphenyl 4,4′-dicarboxylate, the exodentate ligand having two monodentate binding sites is 4,4′-bipyridine and “M” selected from the group consisting of cobalt and zinc.

7. A process for carrying out a chemical reaction and isolating a product thereof, wherein the reactants are contained during the reaction within a polymeric coordination compound of claim 2, the process comprising:
(a) containing within the structure of said polymeric coordination compound of claim 2 one or more reactants;
(b) generating a reactive species from one or more of the contained reactants, thereby causing a reaction that forms one or more of the reaction products; and
(c) converting, by ligand exchange, the polymeric coordination compound to its lower dimensional precursor compound to the extent that the structure is disrupted sufficiently to liberate one or more of the products of the reaction, the ligand exchange being characterized by a substitution of some or all of the exodentate ligands with ligands having a single, monodentate binding site.

8. The process of claim 7, wherein the pillared polymeric coordination compound has the stoichiometric formula [Co₃(bpdc)₃(bpy)].x DMF.z H₂O wherein (bpdc) is a biphenyl-4,4′-dicarboxylate polyfunctional ligand, “bpy” is 4,4′-bipyridine, “DMF” is dimethyl formamide, and “x” and “z” are selected independently to be any number of solvent molecules including 0.

9. The process of claim 7 further comprising the step of treating the polymeric precursor compound with bipyridine under “solvothermal” ligand replacement conditions to yield the pillared porous polymeric compound of claim 4.

10. The process of claim 9 further comprising repeating the process from step “a”, the containing step.

11. A process for synthesizing a compound of claim 1 comprising contacting an inorganic complex of the formula M(NO₃)₂.6(H₂O) with an aliquot of a polyfunctional ligand (“pbd”) and an aliquot of an exodentate ligand (“ed”) under solvothermal conditions wherein the stoichiometric ratio of said inorganic complex to said pbd ligand is 1:1 and the stoichiometric ratio of said inorganic complex to said exodentate ligand is 1:a, wherein “a” is equal to 1 or 4.

12. The compound of claim 1 wherein the repeating structural unit of the compound has the stoichiometric formula [M(pbd)ed].x(sol), where “M” is a transition metal selected from the group of transition metals having in at least one stable oxidation state classified as a Pearson soft or borderline acid, and which, in some oxidation state, can form stable bonds with ligands selected from the group consisting of ligands classified as Pearson hard bases and ligands classified as Pearson borderline bases, “pbd” is a polyfunctional ligand having at least two bidentate binding sites, “ed” is an exodentate ligand having at least two monodentate binding sites, sol is one or more members of the group selected from polar solvents, and “x” is any number, including fractions and zero.

13. The compound of claim 12 wherein “M” is cobalt, “pbd” is biphenyl-4,4′-dicarboxylate, “ed” is 4,4′bipyridine, “sol”=dimethyl formamide, and “x”=0.5, the compound being further characterized in that it has a repeating structural unit comprising two cobalt atoms having octahedral coordination, the coordinating ligands comprising four equatorial biphenyl-4,4′-dicarboxylate ligands wherein one oxygen atom (a binding member) of one bidentate binding site of each of two biphenyl-4,4′-dicarboxylate polyfunctional ligands is coordinated to each of the cobalt atoms, forming a bridge between said cobalt atoms, and one bidentate binding site of each of two additional biphenyl-4,4′-dicarboxylate ligand is coordinated to each cobalt atom, and wherein each cobalt atom of said repeating structural unit is apically coordinated to the nitrogen of one monodentate binding site of each of two 4,4′-bipyridine exodentate ligands.

14. A method for preparing a pillared porous polymeric coordination compound having the stiochiometric formula [Co(bpdc)(bpy)].0.5(DMF), where (bpdc) is a biphenyl-4,4′-dicarboxylate polyfunctional ligand, bpy is a 4,4′-bipyridine exodentate ligand, and DMF is dimethylformamide, comprising contacting a two-dimensional polymeric precursor compound of the stiochiometric formula [Co(bpdc)(py)₂].(H₂O), where (bpdc) is a biphenyl-4,4′-dicarboxylate polyfunctional ligand and (py) is pyridine, with 4,4′-bipyridine under solvothermal ligand-replacement conditions in a ratio of 1 mole of said precursor compound with 4 moles of said bipyridine.
